(19) United States
(12) Patent Application Publication
(10) Pub. No.: US 2026/0085552 A1
(43) Pub. Date: Mar. 26, 2026

(54) MOTOR VEHICLE LOCK

(71) Applicant: Kiekert AG, Heiligenhaus (DE)

(72) Inventors: Ömer INAN, Dorsten (DE); Holger SCHIFFER, Meerbusch (DE); Michael SCHOLZ, Essen (DE); Peter SZEGENY, Engelskirchen (DE)

(73) Assignee: Kiekert AG, Heiligenhaus (DE)

(21) Appl. No.: 19/105,974

(22) PCT Filed: Sep. 1, 2023
(86) PCT No.: PCT/DE2023/100638

§ 371 Date: Feb. 24, 2025

(30) Foreign Application Priority Data
Sep. 21, 2022 (DE) 10 2022 124 186.6

(51) Int. Cl. E05B 81/14; E05B 81/06; E05B 81/44; E05B 81/50

(52) U.S. Cl. CPC E05B 81/14; E05B 81/06; E05B 81/44; E05B 81/50

(57) ABSTRACT

The invention relates to a motor vehicle lock, in particular a motor vehicle door lock, which is equipped with a locking mechanism substantially comprising a rotary latch (1) and a pawl (2). Moreover, an actuating lever chain (4, 5, 9) acting on the locking mechanism (1, 2) is provided with a coupling lever (9), wherein the coupling lever (9), when engaged, closes the actuating lever chain (4, 5, 9) in order to actuate the lock (1, 2) and opens it when disengaged. The coupling lever (9) interacts with a positioning lever (5), which controls the coupling lever, in order to change between at least two stable end positions, “engaged” and “disengaged”. According to the invention, the positioning lever (5) engages, with a pin (7), in a bidirectional slotted link (8) of the coupling lever (9). The bidirectional slotted link (8) is designed in such a way that, when the positioning lever (5) is acted upon, the pin (7) reaches its first end position along a first path (11) and its second end position along a second path (12) separate therefrom.

The invention relates to a motor vehicle lock, in particular a motor vehicle door lock, comprising a locking mechanism consisting substantially of a rotary latch and a pawl, and comprising an actuating lever chain acting on the locking mechanism and having a coupling lever, wherein the coupling lever, in the engaged state, closes the actuating lever chain to act on the locking mechanism and opens it in the disengaged state, and wherein the coupling lever interacts with a positioning lever that controls it in order to change between at least two stable end positions in the sense of “engaged” and “disengaged”.

Motor vehicle locks and in particular motor vehicle door locks of the conventional design according to the type explained above, as described for example in DE 10 2019 133 654 A1 by the applicant have, for example, the coupling lever which is received in or on an actuating lever so as to be pivotable about an axis. For this purpose, the coupling lever has a control cam or slotted link into which the coupling lever can engage by means of a pin. Depending on the position of the coupling lever or its pin within the slotted link, the actuating lever supporting the coupling lever can act on a release lever and, by the actuating lever chain closed in this way, lift the pawl from its engagement with the rotary latch in the locking position of the locking mechanism. In this way, the associated motor vehicle lock or its locking mechanism is opened.

In addition to this engaged state of the coupling lever and the associated one stable end position, however, it is also possible that the coupling lever is pivoted relative to the actuating lever in such a way that the coupling lever cannot be brought into engagement with the release lever when the actuating lever is acted upon. In this case, the coupling lever assumes its disengaged state as a further second stable end position. The previously mentioned control cam or slotted link is provided in the prior art on a control lever.

In this way, the above-described teaching makes it possible to simultaneously lock the actuating lever and unlock the locking mechanism with the aid of an additionally provided electromotive drive unit. This has proven to be fundamentally successful. This gives the electromotive drive or the drive unit in question a dual function.

A comparable prior art, which also describes a generic motor vehicle lock, is the subject of DE 10 2019 127 109 A1. In this case, a coupling lever is again realized which undergoes guidance by means of a slotted link. For this purpose, the coupling lever has a pin which engages in the slotted link. The slotted link is provided in or on an adjusting lever. This means that the lever chain can be moved into a closing actuating position using an emergency actuating lever, with the aid of another realized electromotive drive.

The state of the art has proven itself in principle. However, due to the sometimes complex movement of the coupling lever with its pin inside the slotted link, disruptions or even malfunctions are possible. The invention as a whole seeks to remedy this.

The invention is based on the technical problem of further developing such a motor vehicle lock and in particular a motor vehicle door lock in such a way that the functional reliability is increased and malfunctions are avoided.

To solve this technical problem, the invention proposes in a generic motor vehicle lock and in particular a motor vehicle door lock that the positioning lever engages, with a pin, in a bidirectional slotted link of the coupling lever, wherein the bidirectional slotted link is designed in such a way that, when the positioning lever is acted upon, the pin reaches its first end position along a first path and its second end position along a second path separate therefrom.

The two end positions, i.e., the first end position and the second end position, correspond to the engaged or disengaged state of the coupling lever. Both end positions are maintained in a stable manner. Due to the different ways of assuming the respective end position, possible malfunctions are avoided in principle, in contrast to the prior art.

Within the scope of the exemplary embodiment, the first end position may correspond to the “engaged” position of the coupling lever. By contrast, the second end position belongs to its “disengaged” functional position. Of course, this can also be reversed.

The slotted link guidance within the slotted link of the coupling lever already prevents any malfunctions or disruptions from the outset. This can, in essence, be attributed to the fact that the slotted link as a component of the coupling lever and the two-way structure of the bidirectional slotted link realized at this point and according to the invention ultimately functions and works according to the so-called ballpoint pen principle. A one-time or initial application of the positioning lever actually results in the positioning lever or its pin assuming the first end position along the first path. The same then applies also to the coupling lever with the bidirectional slotted link which is thereby moved to its first end position. In the case of a ballpoint pen, this corresponds to pressing the mechanism once and then clicking it into place.

According to the invention, the repeated application of the positioning lever (advantageously in the same actuation direction) now leads to the pin of the positioning lever reaching and assuming the second end position along the second path, which runs separately from the first path. The same then also applies to the coupling lever. In the case of a ballpoint pen, this corresponds to repeatedly pressing and releasing the locking mechanism described above.

What is crucial in this context and according to the invention is that the first path and the second path are spatially and functionally separated from one another so that both the first end position and the second end position of the pin of the positioning lever inside the bidirectional slotted link of the coupling lever and thus also of the coupling lever as a whole are each assumed safely and stably. In this way, any disruptions or indifferent functional states cannot occur in principle and are also not observed according to the invention.

In order to realize and implement this in detail, the design is further such that the bidirectional slotted link as a component of the coupling lever has at least one separation stop separating the two paths from each other. Usually two separation stops are implemented. In addition to the separation stop, an evasive stop is also provided. The interaction between the evasive stop and the separation stop ensures here that the first path and the second path are spatially and functionally separated from each other and, for the rest, that the first end position and the second end position are each assumed stably and without mutual influence. As already explained, for this purpose and advantageously, two separation stops and the one evasive stop are provided according to the invention inside the slotted link of the coupling lever.

The coupling lever that supports the slotted link is in turn advantageously equipped with a center zero spring. In this context, the center zero spring ensures that the slotted link or the coupling lever has and assumes a basic position from which pivoting movements of the coupling lever and thus also pivoting movements of the slotted link carried by the coupling lever take place against spring force, and the center-zero spring ensures a return starting from this basic position. The center-zero spring can advantageously be designed as a leg spring arranged on a bearing pin of the coupling lever defining a rotation axis, with a winding portion and two legs extending therefrom. In most cases, the procedure is for the winding portion to enclose the bearing pin, which in turn defines the rotation axis for the coupling lever, which can be pivoted relative to the rotation axis. The two legs of the center zero spring, contrastingly, are each arranged on the edge of the coupling lever and act on it accordingly.

In addition, the usual procedure is to assign a return spring to the positioning lever. The return spring ensures that the positioning lever is preloaded or returned towards a basic position. With the positioning lever, the coupling lever also moves into a corresponding basic position because the positioning lever controls the coupling lever via the pin connected thereto. In order to move the coupling lever over the positioning lever, the force of the return spring associated with the positioning lever must therefore be overcome.

In addition, the design is advantageously such that the positioning lever is equipped with a drive, for example an electromotive drive. Of course, manual adjustment of the positioning lever is also possible. By using the drive in question, the positioning lever can now be controlled in such a way that the pin carried by the positioning lever moves within the bidirectional slotted link as part of the coupling lever and assumes at least the first end position and the second end position. In this way, the position of the coupling lever is controlled and specified via the positioning lever.

Furthermore, the positioning lever is advantageously equipped with at least two arms, with a pin arm carrying the pin and with an actuating arm. The electromotive drive may act on the actuating arm and thus ensure the corresponding adjustment movements of the positioning lever and thus of the coupling lever. In most cases, an additional, third arm is also provided, but this is also unnecessary in principle. This can be done in such a way that the arms of the positioning lever and thus the positioning lever as a whole are mounted so as to be rotatable about a common axis.

The actuation of the actuating arm of the positioning lever by means of the electromotive drive can be realized and implemented in every conceivable way. In addition to the manual actuation already mentioned, it is also conceivable that the actuating arm can be acted on directly or indirectly, for example via a locking cylinder. The actuating arm can also be acted on directly or indirectly via the electromotive drive. In the case of an indirect actuation of the actuating arm of the positioning lever via the electromotive drive, an actuator is usually provided between an electric motor and the actuating arm. The actuator can, for example, be a drive wheel on the output side of an electromotive drive, which is set in rotation by means of an electric motor. The rotations of the drive wheel are then in turn transmitted to the actuating arm and thus to the positioning lever which then in turn pivots about its axis and, with the pin it carries, controls the coupling lever in the corresponding direction.

In this way, the overall functional positions of a safety unit such as “unlocked” in the engaged state of the coupling lever and “secured” in the disengaged state can be accordingly realized. In the unlocked position of the safety unit, the engaged coupling lever ensures that the actuating lever mechanism is mechanically closed and consequently, for example, manual actuation of the actuating lever mechanism via an outside or inside door handle leads to the locking mechanism being opened.

By contrast, the secured position of the safety unit and the consequent disengaged position of the coupling lever relative to the actuating lever chain or the actuating lever mechanism belongs to the scenario that a manual actuation of the previously mentioned inside door handle or the outside door handle relative to the locking mechanism has no effect. In addition to this function of the electromotive drive as a component of the safety unit, it is possible within the scope of the invention that, due to the realized slotted link control of the coupling lever, the electromotive drive for the positioning lever can in principle also open the locking mechanism in question by electric motor, as is described in detail in the generic prior art according to DE 10 2019 133 654 A1. Either way, the design according to the invention of the slotted link as a bidirectional slotted link inside the coupling lever with the first path and the second path separate therefrom and the two stable end positions achieved thereby ensures a particularly functional structure. This prevents any malfunctions. These are the main advantages.

In the following, the invention is explained in more detail with the aid of a drawing showing only an exemplary embodiment; in the figures:

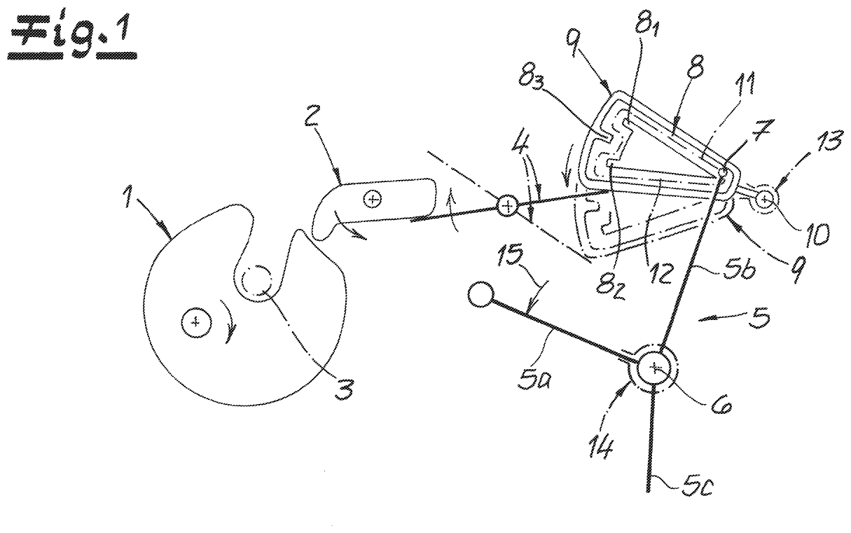

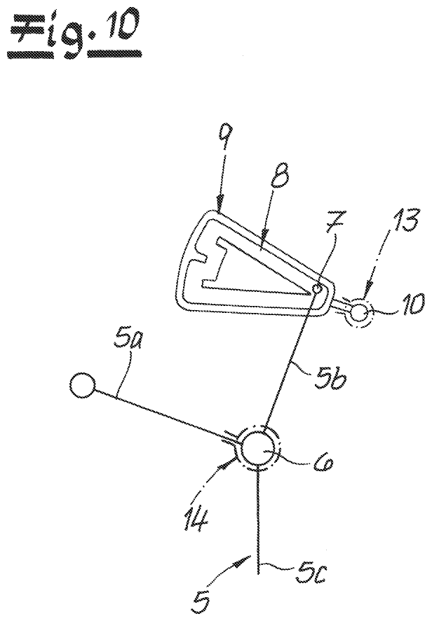

FIG. 1 shows the motor vehicle lock according to the invention in its basic position or in the “disengaged” state of the safety unit corresponding to the second end position according to FIG. 10 in solid lines and, in dash-dotted lines, the position of the coupling lever in its first end position,

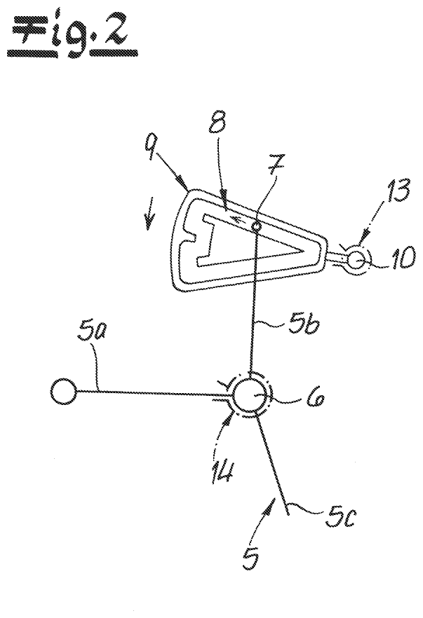

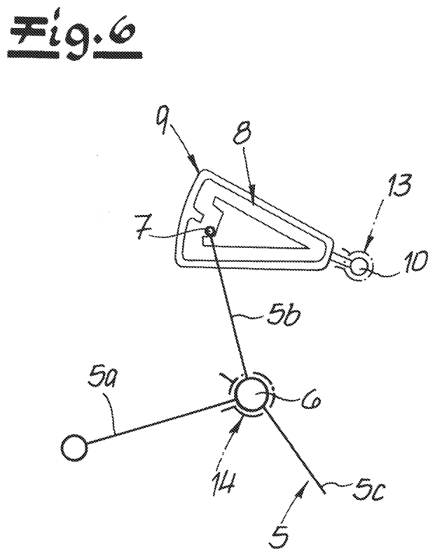

FIGS. 2 to 6 show the transition of the motor vehicle lock according to the invention from the basic position or second end position according to FIG. 1 in the transition to the first end position in the representation according to FIG. 6 along a first path, and

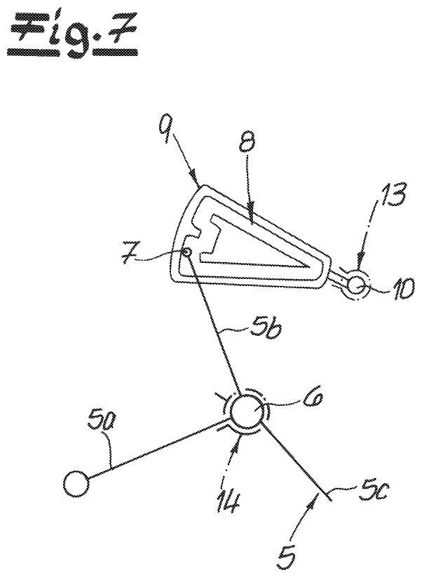

FIGS. 7 to 10 show the travel path of the positioning lever and thus also of the coupling lever starting from the first end position according to FIG. 6 along the second path up to its second stable end position in the representation according to FIG. 10, which coincides with the previously mentioned basic position according to FIG. 1.

In the drawings, a motor vehicle lock is shown, which is a motor vehicle door lock. This is reduced to its essential elements for the invention. The motor vehicle lock or motor vehicle door lock in fact has a locking mechanism 1, 2 consisting of a rotary latch 1 and a pawl 2, which is merely indicated in FIG. 1. In addition, a locking bolt 3 can be seen, caught by the rotary latch 1 as well as a release lever 4 and a coupling lever 9.

The release lever 4 and the coupling lever 9 together define an actuating lever chain 4, 5, 9 which, in addition to the release lever 4 and the coupling lever 9, also includes a positioning lever 5. With the help of the actuating lever chain 4, 5, 9, the locking mechanism 1, 2 shown in FIG. 1 can be opened. According to the exemplary embodiment, an opening movement of the locking mechanism 1, 2 shown in the closed state in FIG. 1 corresponds to the coupling lever 9 being in its engaged state shown by dash-dotted lines. By contrast, the state of the coupling lever 9 in solid lines corresponds to its disengaged position. An associated safety unit containing the coupling lever 9 is consequently in its “unlocked” position in the engaged state and assumes its “secured” position when the coupling lever 9 is in its disengaged state.

According to the exemplary embodiment, the change of the coupling lever 9 from its “disengaged” position shown in solid lines to its “engaged” position corresponds to the coupling lever 9 performing a pivoting movement in an counterclockwise direction about its axis 10.

The engaged state of the coupling lever 9 according to the dash-dotted representation in FIG. 1 now leads to a pivoting movement of the coupling lever 9 about its axis 10 in the counterclockwise direction indicated in FIG. 1 and thus also of the actuating lever mechanism or the actuating lever chain 4, 5, 9, in that the coupling lever 9 works on the release lever 4 and pivots the release lever 4 clockwise about its axis. As a result, the release lever 4 pivoted clockwise can rotate the pawl 2 counterclockwise, as indicated in FIG. 1. This results in the pawl 2 being released from its latching engagement with respect to the rotary latch 1 in the closed state of the locking mechanism 1, 2 shown there. The locking mechanism 1, 2 or the rotary latch 1 is opened so that the rotary latch 1 swings open in the clockwise direction indicated in FIG. 1 and releases the locking bolt 3. The same applies to an associated motor vehicle door that is not expressly shown.

In any case, the overall design is such that the actuating lever chain 4, 5, 9 working on the locking mechanism 1, 2 is equipped with the previously mentioned coupling lever 9. In its engaged state shown in dash-dotted lines in FIG. 1, the coupling lever 9 ensures that the actuating lever chain 4, 5, 9 is closed to act on the locking mechanism 1, 2. By contrast, the assumed disengaged state of the coupling lever 9 shown in solid lines in FIG. 1 means that the actuating lever chain 4, 5, 9 is open. Corresponding action on an actuating lever and thus on the coupling lever 9 consequently has no effect with regard to the locking mechanism 1, 2. In such a case, it cannot be opened.

So that the coupling lever 9 can now be safely moved back and forth between the two previously described stable end positions, namely the disengaged state shown in solid lines in FIG. 1 or the basic position shown here and the engaged position of the coupling lever 9 according to the dash-dotted representation or according to the functional position in FIG. 6, and so that malfunctions are not observed, the previously mentioned positioning lever 5 is provided and is mounted so as to be rotatable about an associated axis 6. The positioning lever 5 has a pin 7. The pin 7 engages here in a bidirectional slotted link 8 of the coupling lever 9. For this purpose, the bidirectional slotted link 8 is designed such that by acting on the positioning lever 5, the pin 7 reaches its first end position along a first path 11 corresponding to the representation in FIG. 6, and its second end position along a second path 12, separate therefrom, as shown in FIG. 10 and FIG. 1. In fact, the second end position corresponds to the solid line position of the coupling lever 9 in FIG. 1, whereas the dash-dotted position of the coupling lever 9 represents the first end position comparable to FIG. 6.

For this purpose, the positioning lever 5 is designed as an adjusting lever, as is also provided in comparable motor vehicle locks and in particular in the generic prior art according to DE 10 2019 133 654 A1. As already described, the pin 7 on the positioning lever 5 can cover the overall first path 11 within the slotted link 8 of the coupling lever 9 until the first end position of the pin 7 is reached in the functional position according to FIG. 6. In addition, the pin 7 is able to complete the second path 12, starting from the first end position corresponding to the representation in FIG. 6 up to the second end position as shown in FIG. 10 and in the same way in solid lines in the basic position according to FIG. 1. In the context of the exemplary embodiment, the second end position according to FIG. 1 or 10 may belong to the “secured” position of the safety unit, which accordingly corresponds to the “disengaged”state of the coupling lever 9.

By contrast, the first end position in the functional position according to FIG. 6 represents the “unlocked” state of the safety unit and, accordingly, the “engaged”functional position of the coupling lever 9.

The safety unit may basically be a locking unit, a child safety unit, an anti-theft unit or even combinations.

It can be seen that the slotted link 8 is not only designed as a bidirectional slotted link 8, but is also designed such that, by acting on the positioning lever 5, the pin 7 reaches the first end position in FIG. 6 along its first path 11 and, after again acting on the positioning lever 5 (in the same actuating direction), it moves along the second path 12 separate therefrom to the second end position corresponding to the representation in FIG. 10 or in solid lines in FIG. 1. Both paths 11 and 12 are spatially and functionally separated from each other. The positioning lever 5 is actuated by a drive here which, in the exemplary embodiment, is designed as an electromotive drive 15 and is only shown in basic form in FIG. 1. In fact, the electromotive drive 15 has an electric motor that works on an output-side driven pulley which in turn acts on an actuating arm 5a of the positioning lever 5. In addition to the actuating arm 5a, the positioning lever 5 also has a pin arm 5b which carries the pin 7 that penetrates into the bidirectional slotted link 8. In the context of the exemplary embodiment, a further third arm 5c is also realized which, however, is also unnecessary in principle. Both arms 5a, 5b or all three arms 5a, 5b and 5c of the positioning lever 5 are all rotatably mounted about the common axis 6.

The previously described spatial and functional separation of the two paths 11, 12 from each other results according to the exemplary embodiment in that the slotted link 8 functions according to the ballpoint pen principle already described in the introduction. This is because the one-time and initial actuation of the positioning lever 5 starting from the functional position in FIG. 1 or corresponding to the second end position according to FIG. 10 results in the pin 7 arranged on the pin arm 5b of the positioning lever 5 moving into the first end position according to FIG. 6 and being locked or held there, as it were. For this purpose, the bidirectional slotted link 8 is equipped with a separation stop 8₁ separating the two paths 11, 12 from each other. According to the exemplary embodiment, two separation stops 8₁, 8₂ are provided. In addition to the two separation stops 8₁, 8₂, an evasive stop 8₃ can also be seen.

The two separation stops 8₁, 8₂ are located here on both sides of the evasive stop 8₃, which is provided opposite a recess formed between the two separation stops 8₁, 8₂, into which recess the pin 7 dips at the end of the first path 11 and, in the first end position according to FIG. 6, is held in contact with the separation stop 8₂.

The coupling lever 9 is equipped with a center-zero spring 13 which is merely suggested. According to the exemplary embodiment, the center zero spring 13 is designed as a leg spring and, with its winding portion, encloses the bearing pin defining the axis 10 of the coupling lever 9. In addition, two legs extending from the winding portion are provided. The positioning lever 5 is in turn equipped with a return spring 14 which ensures that the positioning lever 5 is transferred to its basic position shown in FIGS. 1 and 10 or the second stable end position (“secured” position of the safety unit or “disengaged” position of the coupling lever 9).

The mode of operation is as follows. Starting from the second end position or basic position of the coupling lever 9 shown in FIG. 1 by solid lines or in FIG. 10 (“secured” or “disengaged”), an actuation of the positioning lever 5 or its actuating arm 5a by means of the electromotive drive 15 in the counterclockwise direction indicated in FIG. 1 about its axis 6 results in the pin 7, starting from the second end position or basic position in FIG. 1, describing the first path 11 within the slotted link 8. This can be seen in the transition from FIG. 1 to FIG. 2. The return spring 14 acting on the positioning lever 5 is tensioned. At the same time, during its movement along the first path 11 within the slotted link 8, the pin 7 ensures that the coupling lever 9 carrying the slotted link 8 is pivoted slightly about its axis 10 in a counter clockwise direction during the transition from FIG. 1 to FIG. 2.

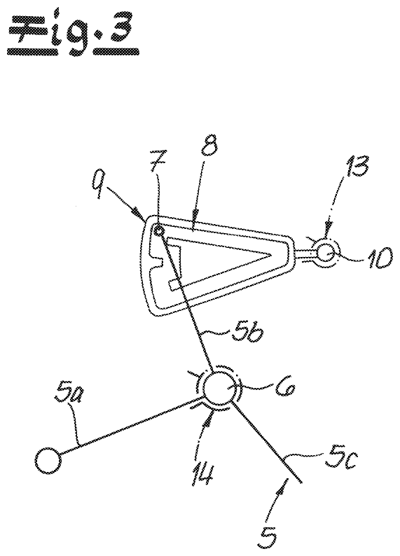

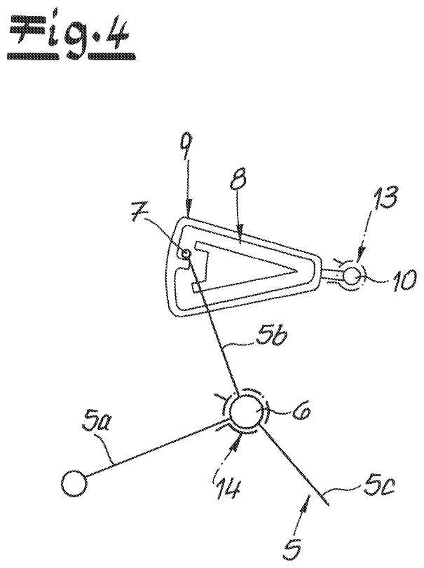

The pin 7 on the pin arm 5b of the positioning lever 5 now moves along the first path 11 until the pin 7 reaches the end position shown in FIG. 3 within the slotted link 8. The positioning lever 5 is now deflected to the maximum extent about its axis 6 and ultimately reaches the “engaged” position of the coupling lever 9 shown in dash-dotted lines in FIG. 1. During the further movement of the pin 7 within the slotted link 8 during the transition from FIG. 3 to FIG. 4, the center zero spring 13 acting on the coupling lever 9 ensures that the coupling lever 9 and thus also the slotted link 8 are reset. This is because, during the transition from FIG. 1 to FIG. 2 and further to FIG. 3, the coupling lever 9 together with the slotted link 8 has been pivoted counterclockwise about its axis 10 so that the center zero spring 13 has been deflected. After reaching the functional position in FIG. 3, the center zero spring 13 ensures that the coupling lever 9 and with it the slotted link 8 are returned in a counterclockwise direction, as can be seen from a transition from FIG. 3 to FIG. 4. Now, the pin 7 lies against the evasive stop 8₃.

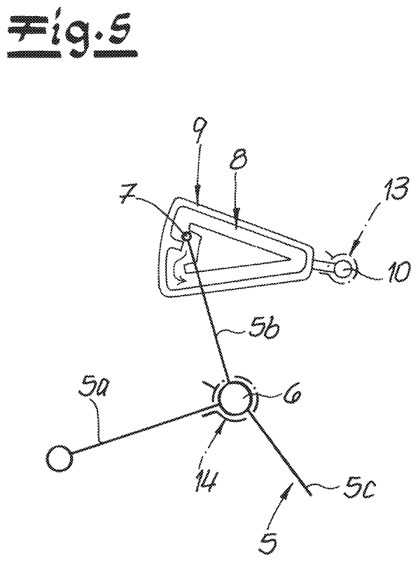

As a result, the return spring 14 acting on the positioning lever 5 can return the positioning lever 5 clockwise during the transition from FIG. 4 to FIG. 5 far enough until the pin 7 comes to rest at the recess between the two separation stops 8₁ and 8₂. This is shown in FIG. 5. During the further transition from FIG. 5 to FIG. 6, the center zero spring 13 again ensures that the coupling lever 9 and with it the slotted link 8 are acted upon clockwise about the axis 10 in the direction of the basic position of the coupling lever 9 and the slotted link 8, corresponding to the representation in FIG. 1. As a result, ultimately and at the end of the first path 11, the pin 7 is moved so that it reaches the first end position, as shown in FIG. 6. This end position in FIG. 6 is assumed in a stable manner because the coupling lever 9 and with it the slotted link 8 are (slightly) preloaded clockwise with respect to the axis 10 by means of the center zero spring 13.

In order to be able to move from this stable first end position of the pin 7 in the slotted link 8 and thus also of the coupling lever 9 in the “engaged” position according to FIG. 6 or “unlocked” of the safety unit again to the second end position according to the functional position according to FIG. 10 or 1, it is necessary that the positioning lever 5 is actuated again so that the pin 7 can complete the second path 12 separately from the first path 11 until it reaches the second end position in the representation according to FIG. 10. This process can be seen in the transition from FIG. 6 to FIG. 7. In fact, the actuation of the positioning lever 5 by means of the electromotive drive 15 in this case corresponds to the positioning lever 5 being acted upon again about its axis 6 in a counterclockwise direction.

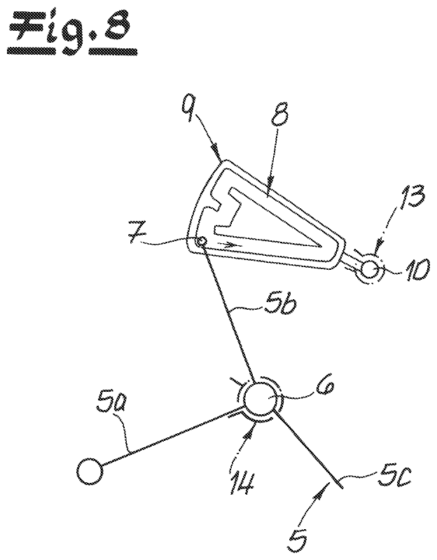

For this purpose, the associated actuating arm 5a of the positioning lever 5 may be actuated manually or, according to the exemplary embodiment, by means of the electromotive drive 15, as explained in the introduction to the description. This means that, comparably to the ballpoint pen principle already explained above, a renewed actuation of the positioning lever 5 ensures that the previously achieved locking or the reaching of the first end position in the representation according to FIG. 6 is canceled after the pin 7 has completed the first path 11 and also is able to be canceled. The actuation of the positioning lever 5 on its actuating arm 5a in a counterclockwise direction about its axis 6 during the transition from FIG. 6 to FIG. 7 now results in the pin 7 being able to leave the lower separation stop 8₂. As a result, the center zero spring 13 is able to act on the coupling lever 9 about its axis 10 in a counterclockwise direction so that the pin 7 changes from the functional position according to FIG. 7 to the position according to FIG. 8.

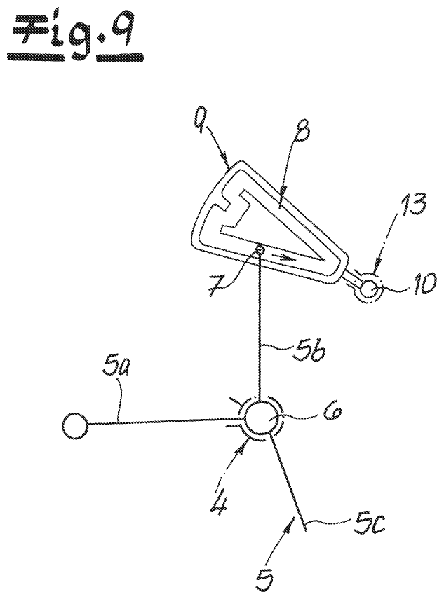

Starting from the functional position in FIG. 8 on the part of the pin 7, the return spring 14 acting on the positioning lever 5 now ensures that the positioning lever 5 is pivoted about its axis 6 in a clockwise direction and is thereby moved along the second path 12 in the direction of its second end position corresponding to the representation in FIGS. 10 and 1. This can be seen in the transition from FIG. 8 to FIG. 9. During this process, the return spring 14 acting on the positioning lever 5 ensures that the positioning lever 5 is pivoted clockwise about its axis 6. In addition, the pin 7 moved along the second path 12 at the end of the pin arm 5b of the positioning lever 5 pivots the coupling lever 9 and with it the slotted link 8 about the axis 10 in a clockwise direction beyond the basic position shown in FIG. 1, as can be seen in the transition from FIG. 8 to FIG. 9.

As soon as the pin 7 has reached a free region at the end of the second path 12, the coupling lever 9 can be reset again by means of the center zero spring 13, which corresponds to the coupling lever 9, and with it the slotted link 8, pivoting counterclockwise about the associated axis 10, as is evident in the transition from FIG. 9 to FIG. 10. Now, the positioning lever 5 or the coupling lever 9 has reached its second end position corresponding to the basic position in FIG. 1, as also shown at the end of the second path 12 in FIG. 10.

### LIST OF REFERENCE SIGNS

1 rotary latch
2 pawl
3 locking bolt
4 release lever
5 positioning lever
5a actuating arm
5b pin arm
5c optional third arm
6 common axis
7 pin
8 bidirectional slotted link
8₁ separation stop 1
8₂ separation stop 2
8₃ evasive stop
9 coupling lever
10 rotation axis
11 first path
12 second path
13 center-zero spring
14 return spring
15 electromotive drive

1. A motor vehicle lock, door lock, comprising:
a locking mechanism including:
a rotary latch, and
a pawl, and
an actuating lever chain configured to act on the locking mechanism, the actuating lever chain including a coupling lever and a positioning lever,
wherein the coupling lever, when engaged, closes the actuating lever chain in order to actuate the motor vehicle lock and opens the actuating lever chain when disengaged,
wherein the coupling lever interacts with the positioning lever configured to control, the coupling lever, in order to change between at least two stable end positions, including an engaged position and a disengaged position,
wherein the coupling lever includes a bidirectional slotted link with a pin,
wherein the bidirectional slotted link includes a first path having a first end position and a second path having a second end position,
wherein the positioning lever engages with the pin of the bidirectional slotted link of the coupling lever, and
wherein the bidirectional slotted link is designed in such a way that, when the positioning lever is acted upon, the pin reaches the first end position along the first path and the second end position along the second path.

2. The motor vehicle lock according to claim 1, wherein the bidirectional slotted link has at least one separation stop separating the first path from the second path.

3. The motor vehicle lock according to claim 2, wherein the bidirectional slotted link further includes an evasive stop.

4. The motor vehicle lock according to claim 3, wherein the at least one separation stop and the evasive stop are provided inside the bidirectional slotted link.

5. The motor vehicle lock according to claim 1, wherein the coupling lever includes a center zero spring.

6. The motor vehicle lock according to claim 5, wherein the coupling lever includes a bearing pin defining a rotation axis.

7. The motor vehicle lock according to claim 1, wherein the positioning lever includes a return spring.

8. The motor vehicle according to claim 1, wherein the positioning lever includes a drive.

9. The motor vehicle lock according to claim 1, wherein the positioning lever includes a pin arm carrying the pin and an actuating arm.

10. The motor vehicle lock according to claim 9, wherein the actuating arm and the pin arm are mounted rotatably about a common axis.

11. The motor vehicle lock according to claim 6, wherein the center zero spring is designed as a leg spring arranged on the bearing pin, and wherein the leg spring includes a winding portion and two legs.

12. The motor vehicle according to claim 8, wherein the drive is an electromotive drive.

13. The motor vehicle according to claim 10, wherein the positioning lever further includes a third arm mounted rotatably about the common axis.

14. The motor vehicle according to claim 12 the positioning lever further includes an actuator provided between the electromotive drive and the actuating arm.
